(19) United States
(12) Patent Application Publication
(10) Pub. No.: US 2013/0293059 A1
(43) Pub. Date: Nov. 7, 2013

(54) CARBON BRUSH WITH DISCONNECTION APPARATUS

(71) Applicant: Manfred Lutz, Filderstadt (DE)

(72) Inventor: Manfred Lutz, Filderstadt (DE)

(73) Assignee: Robert Bosch GmbH, Stuttgart (DE)

(21) Appl. No.: 13/880,754

(22) PCT Filed: Oct. 11, 2011
(86) PCT No.: PCT/EP11/67704

§ 371 Date: Jul. 2, 2013

(30) Foreign Application Priority Data
Oct. 22, 2010 (DE) 10-2010-042-807.8

(51) Int. Cl. H01R 39/59

(52) U.S. Cl. CPC H01R 39/59
USPC 310/247

(57) ABSTRACT

A carbon brush with a disconnection apparatus has, in a cavity in the brush body, a disconnection body. The disconnection body includes an electrically insulating material and a prestressed compression-spring body. The compression-spring body is configured to act resiliently on the disconnection body. At least one of the compression-spring body and the disconnection body is formed from plastic.

### PRIOR ART

The invention is based on a carbon brush with disconnection apparatus according to the preamble of claim 1.

Carbon brushes of this type are known (DE 1 679 529 U1) in which the compression-spring body consists of a cylindrical helical spring made of spring steel, which, in order to achieve the lowest overall length of the system of the disconnection apparatus and the greatest possible wear travel of the brush body, can be preloaded and compressed at most to such an extent that the cylindrical turns thereof rest on one another and the spring is preloaded to form a block. As a result the maximum usable wear travel of the brush body is determined, which results from the ratio of the possible theoretical wear travel of the carbon brush to the length of the disconnection apparatus. A low wear travel as a real useful length of the brush body requires early replacement of the carbon brushes when the latter have exceeded the permissible wear travel. Cylindrical helical springs made of metal as compression-spring bodies are costly and can be damaging, e.g. break. They have a low flexural rigidity. During the disconnection operation, when the compression-spring body has already lifted the brush body from the commutator of an electric motor and has interrupted the power circuit, the electric motor continues to run down. In the case of unbraked machines at idle, this running down can last for 5 to 15 seconds. During this time, transverse forces act on the compression-spring body as a result of the contact of the disconnection body with the rotating commutator, which may lead to severe misalignment of the cylindrical helical spring with damage to the latter and to the disconnection body tearing out as a result of this severe misalignment. In both cases, damage can be caused to the commutator, as far as the complete destruction of the electric motor.

### DISCLOSURE OF THE INVENTION

The carbon brush with disconnection apparatus according to the invention has the advantage that, on account of the plastic material, the costs for the carbon brush can be reduced and, furthermore, a shorter, compact design of the disconnection apparatus can be achieved. Plastic material also has the advantage of easier shaping for different configurations. Furthermore, as a result the preconditions are created for the components comprising compression-spring body and disconnection body to be configured as a one-piece component. The use of different plastic materials for the compression-spring body, on the one hand, and the disconnection body, on the other hand, is also possible in a one-piece configuration; the disconnection apparatus can also be produced in the two-component process. Since plastic material has a sealing action in a corresponding configuration, on account of the springy behavior, under certain circumstances it is possible to omit a separating disk on the upper side, which is otherwise needed in the case of metallic springs in order that no metallic powder gets into the cavity in the brush body during the plugging operation, as a result of which a metallic spring there could jam. By means of appropriate configuration of the springy compression-spring body from plastic, the flexural rigidity of the latter can also be increased as compared with cylindrical metallic helical springs, so that the compression-spring body can also withstand large transverse forces without severe misalignment, and thus damage to the commutator of the electric motor, to the carbon brushes and to other components of an electrical appliance is reliably avoided and repair costs necessitated thereby are dispensed with.

By means of the measures listed in the further claims, advantageous developments and improvements of the carbon brush specified in claim 1 are possible.

An advantageous refinement of the carbon brush provides for the compression-spring body to be formed from thermoplastic. Here, the compression-spring body and the disconnection body can also be combined to form an integral one-piece plastic component. Such a one-piece component as a disconnection apparatus is particularly simple and cost-effective. Depending on configuration, in said component the axial dimension of the disconnection apparatus can be kept small and, as a result, the useful wearing length of the carbon brush can be increased still further, with all the advantages resulting therefrom.

Another advantageous embodiment provides for the compression-spring body to consist of an elastomer. It may also be advantageous in this case if the compression-spring body and the disconnection body are formed as a one-piece component.

A further advantageous embodiment provides for the compression-spring body to be formed from at least one spring made of plastic material. The spring can be formed as a spring bellows, for example, or have spring turns. In this case, it may be advantageous if the spring turns, in the preloaded, compressed state, are located at least partly one inside the other, when shortening the spring. As a result, a shortening in the area of the compression-spring body in the preloaded state can be achieved, with the result that an increase in the usable wearing length of the carbon brush is achieved. It goes without saying that, even in the case of a compression-spring body configured in this way, the latter can be combined with the plastic disconnection body to form an integral one-piece component. Even different materials for the part which represents the compression-spring body and for the other part of the one-piece component forming the disconnection body are possible, it being possible for production to be carried out in the two-component process.

It may also be advantageous if the compression-spring body closes the end of the cavity in the brush body while sealing against ingress of material from a plug to be introduced above. As a result, it is possible to dispense with a special separating disk. This leads to a reduction in the axial dimensions of the disconnection apparatus and also reduces the costs because of the omission of the separating disk. As a result, the disconnection apparatus becomes even more compact. To seal the cavity against the ingress of material of the metallic powder during the plugging operation, use is made of the sealing action of the plastic material.

It may also be advantageous if the compression-spring body is formed from a plastic foam body. One such compression-spring body consists of foamed plastic and has an adequately springy behavior. In this case, the compression-spring body can, for example, be formed from a compressible polyurethane foam and have an approximately cylindrical body in the design as a one-piece component, which is effective as a spring buffer and, at the lower end in the one-piece configuration, forms the part which is a disconnection body in a two-part design. In this way, a particular simplification is achieved. The number of necessary components of the disconnection apparatus is reduced to this one-piece plastic foam body which, on account of the sealing behavior, also makes a separating disk underneath the plug unnecessary. In the cavity of the brush body there is only the plastic foam body, the cavity being closed at the open end by means of the plug, which absorbs the supporting forces for the plastic foam body.

It may also be advantageous if the compression-spring body, on its own or in the form of the one-piece component with the disconnection body, is formed as a hollow body or as a solid body.

It may also be advantageous if the compression-spring body has at one end a cylindrical extension in one piece therewith, which is pressed into the cavity as a press-in part and is held therein tightly and firmly by a press fit. As a result, the springy behavior of the plastic material is not only used for sealing the cavity but also for pressing into the cavity, by which means the compression-spring body is connected firmly to the brush body by means of a press fit with additional sealing in such a way that the supporting forces of the compression-spring body are also absorbed by the press fit.

The invention is explained in more detail in the following description by using exemplary embodiments illustrated in the drawings, in which, in each case in a schematic representation:

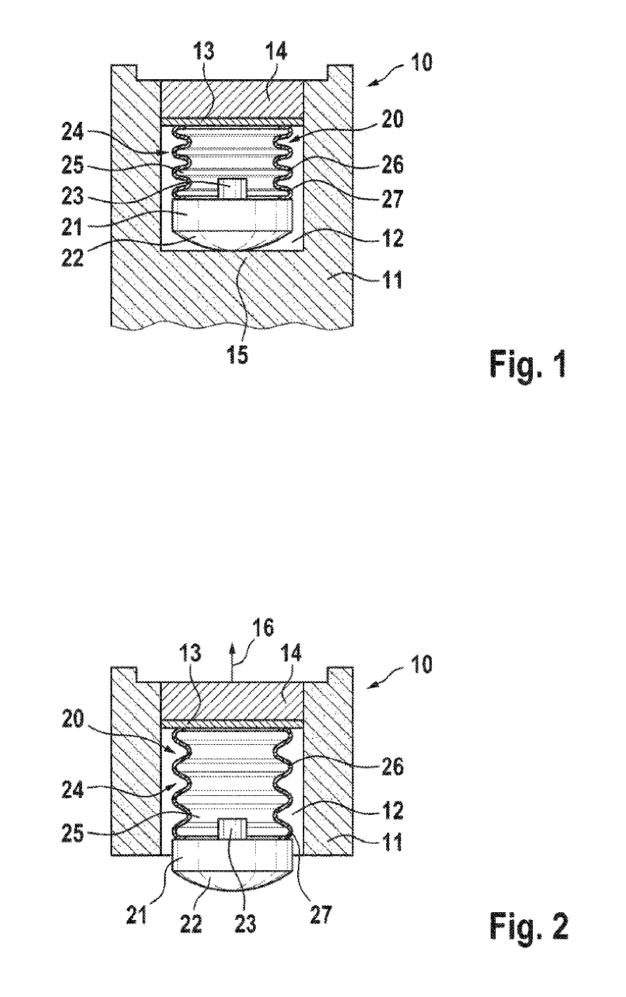

FIG. 1 shows a schematic section with a partial side view of part of a carbon brush with disconnection apparatus according to a first exemplary embodiment with the compression-spring body loaded,

FIG. 2 shows a schematic section of the carbon brush from FIG. 1 with the compression-spring body unloaded,

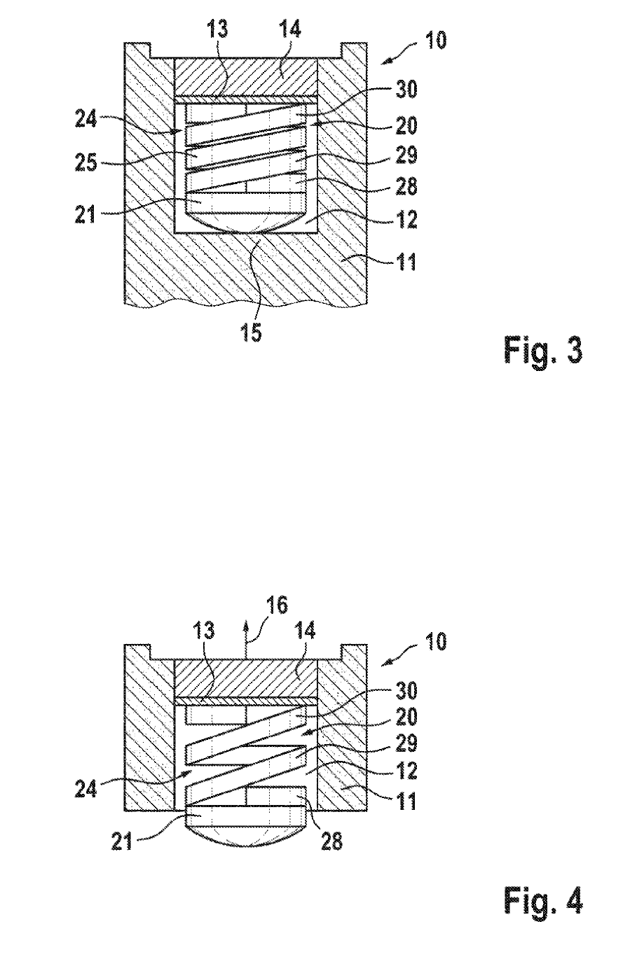

FIG. 3 shows a schematic section with a partial side view of part of a carbon brush with disconnection apparatus according to a second exemplary embodiment with the compression-spring body loaded,

FIG. 4 shows a schematic section of the carbon brush in FIG. 3 with the compression-spring body unloaded,

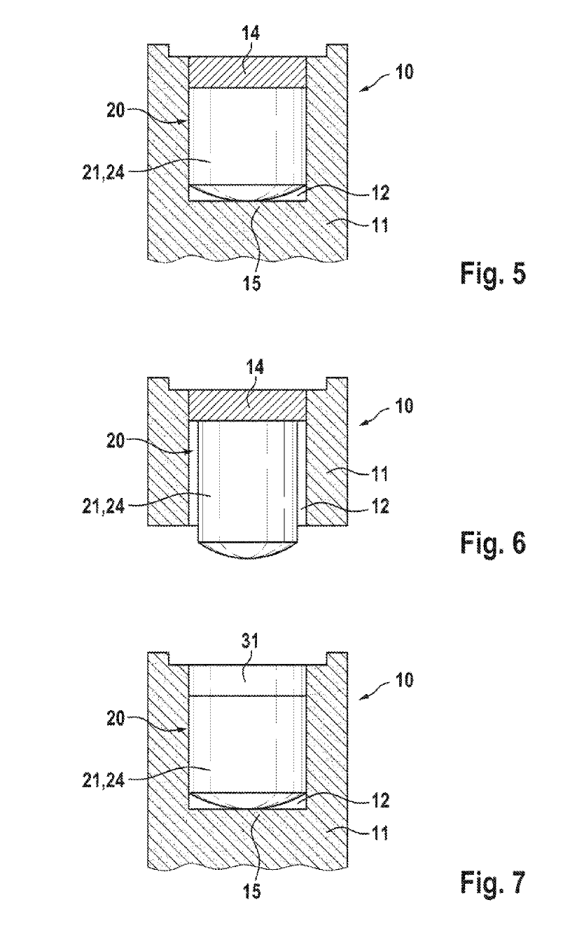

FIG. 5 shows a schematic section with a partial side view of part of a carbon brush with disconnection apparatus according to a third exemplary embodiment with the compression-spring body loaded,

FIG. 6 shows a schematic section of the carbon brush in FIG. 5 with the compression-spring body unloaded,

FIG. 7 shows a schematic section with a partial side view of part of a carbon brush with disconnection apparatus according to a fourth exemplary embodiment with the compression-spring body loaded.

In FIGS. 1 and 2, a first exemplary embodiment of a carbon brush 10 with disconnection apparatus 20 is shown. In a known way, carbon brushes 10 of this type produce the electrical contact with the commutator of electric motors, as are used, for example, for electrical appliances for domestic use or handicraft, in particular also for hand-held electric machine tools. Carbon brushes 10 of this type comprise a brush body 11 made of graphite, into which the electrical terminal is usually pressed or connected thereto in another way. The necessary contact pressure with which the brush body 11 is pressed against the commutator of the electric motor is provided by a spring element, for example in the form of a spiral spring (EP 0 937 320 B1).

The disconnection apparatus 20 has the purpose of protecting the commutator of the electric motor against mechanical damage or burning after the carbon brushes have worn out. The disconnection apparatus 20 has a disconnection body 21 made of electrically insulating material, which is formed as a pin or disconnection nipple. In the first exemplary embodiment shown, the disconnection body 21 has a rounded head 22 with a pin attachment 23 on the rear side. Also provided is a preloaded compression-spring body 24 loading the disconnection body 21 resiliently downward in FIG. 1, which acts with one end on the disconnection body 21. The brush body 11 is provided with a cavity 12, for example a cylindrical cavity, in which the compression-spring body 24 and the disconnection body 21 are held. At the upper end in FIG. 1, the cavity 12 is closed by a separating disk 13, on which the compression-spring body 24 is supported, what is known as a plug 14 made of metallic powdery materials being provided above the separating disk 23, by which the supporting forces of the compression-spring body 24 are absorbed and led into the brush body 11. The separating disk 13 prevents metal powder getting into the area of the cavity 12 and therefore into the area of the compression-spring body 24 during the plugging process, which could lead to interference during the disconnection operation. In FIG. 1, the disconnection apparatus 20 is illustrated in the loaded state of the compression-spring body 24, the brush body 11 not being shown with regard to its complete length but broken off.

As a result of the unavoidable ablation on account of the contact between the carbon brush and the commutator (not shown) of the rotor of an electric motor, wear takes place in the carbon brush 10, specifically in the end region which is located opposite the end containing the disconnection apparatus 20. Following complete wearing of the carbon brush 10 during operation, the disconnection body 21 breaks through the material of the carbon brush 10 located in the adjacent area 15 and, under the action of the compression-spring body 24, comes into touching contact with the commutator. As a result, the disconnection body 21 forces the remaining brush body 11 away from the commutator, not shown, in the direction of the arrow 16 via the expanding compression-spring body 24, by which means the power flow is interrupted and the electric motor is then switched off in a controlled manner. In order to ensure the disconnection operation, the brush body 11 should lift off the commutator by at least 1 mm, for example. This is achieved by means of appropriate preloading of the compression-spring body 24, the latter having to ensure that the requisite spring force is applied over the necessary spring travel. Because of this action of the disconnection apparatus 20, damage to the commutator of the rotor of an electric motor is avoided, so that it is necessary for only the worn carbon brushes 10 to be replaced by unused new ones by the user or the service workshop.

It can be seen that the individual components of the disconnection apparatus 20, that is to say the disconnection body 21, the compression-spring body 24, the separating disk 13 and the plug 14, necessitate a certain overall length of the system and determine the usable wear travel of the carbon brush 10. The overall length of the carbon brush 10 is usually predefined by the construction of the electrical appliance, so that, with an appropriate overall length of the system of the disconnection apparatus 20, a remaining wear travel remains as real usable length. When this wear travel is exceeded, replacement of the carbon brushes 10 is needed.

The compression-spring body 24 according to the first exemplary embodiment and according to the invention is formed of plastic and springy. It consists of an elastomer, for example. The compression-spring body 24 has the shape of a spring 25, this spring 25 being formed as a spring bellows 26, for example, the wall 27 of which is corrugated, which results in rib-like projections which either run approximately annularly and parallel to one another in relation to the longitudinal mid-axis or which run spirally. The spring 25 is formed as a hollow body, for example. The disconnection body 21 is fixed to the lower end of this compression-spring body 24 in the drawing. The upper end of the cavity 12 is closed by means of the separating disk 13, above which the plug 14 is provided. The configuration of the compression-spring body 24 from plastic makes it possible, on account of the sealing action of the plastic material, to omit the separating disk 13 and to use the compression-spring body 24 directly with the upper end as a sealing element. If an in particular cylindrical extension is molded on in one piece at the upper end of the compression-spring body 24, the compression-spring body 24 can be pressed with this extension into the cavity 12 from above. The extension is dimensioned such that the latter is held in the cavity 12 by means of a press fit and, as a result, replaces the plug 14, which leads to a further simplification.

The disconnection body 21 can consist of insulating material, in particular plastic, for example of a fiber-reinforced plastic.

In another embodiment, which is not shown but is particularly advantageous, the compression-spring body 24 and the disconnection body 21 according to FIGS. 1 and 2 are combined to form an integral one-piece plastic component. This is particularly advantageous in view of the axial dimensions and in view of the costs, since a one-piece element 21, 24 is particularly cost-effective and, as a result, the number of necessary components of the disconnection apparatus 20 is also reduced. In the case of this one-piece configuration, production of this one-piece component 21, 24 from different plastic materials in accordance with the two-component process is also possible. In the configuration as a spring bellows 26, the compression-spring body 24 is a hollow body. It can be seen that other configurations, in which the compression-spring body 24 and/or the disconnection body 21 are formed of plastic, also lie within the knowledge of those skilled in the art.

In the second exemplary embodiment, shown in FIGS. 3 and 4, the compression-spring body 24 is once more made of plastic and springy. It can be formed of a thermoplastic. The compression-spring body 24 is formed as an approximately cylindrical helical spring 25 having a plurality of spring turns 28, 29, 30, the spring turns running spirally. Instead of this, the compression-spring body 24 according to FIGS. 3 and 4 can also have such spring turns which, at least in the preloaded, compressed state, are located at least partly one inside the other, when shortening the compression-spring body 24. Illustrated in FIGS. 3 and 4 at the upper end of the cavity 12 is a separating disk 13, which is necessary when the spring 25 is not able to seal the cavity 12 against the material of the plug 14 on the basis of its material-based sealing capacity. The compression-spring body 24 and the disconnection body 21 are combined to form an integral one-piece plastic component and thus constitute a one-piece component of the disconnection apparatus 20. The plastic material of this one-piece component 21, 24 is electrically insulating and is thus best suited to this one-piece configuration of disconnection body 21 and compression-spring body 24. Here, too, the spring 25 at the upper end as a replacement for the separating disk 13 and the plug 14 can have a sealing, cylindrical, therefore one-piece, extension, which is pressed firmly and tightly into the cavity 12 as a press-in part and seals said cavity and absorbs the supporting force from the spring 25.

In the third exemplary embodiment, shown in FIGS. 5 and 6, the disconnection body 21 and the compression-spring body 24 are likewise combined to form a one-piece plastic component, this one-piece component consisting of a plastic foam body here, for example made of compressible springy polyurethane foam. The one-piece component comprising disconnection body 21 and compression-spring body 24 can be configured as a hollow body or as a solid body. FIGS. 5 and 6 reveal that, in this exemplary embodiment, the separating disk 13 is not present. The end of the cavity 12 is sealed off by the material-based sealing behavior of the one-piece plastic component 21, 24.

The fourth exemplary embodiment, shown in FIG. 7, differs from that in FIGS. 5 and 6 in that, at the upper end in the drawing, the compression-spring body has a cylindrical extension 31 in one piece therewith, which is pressed into the cavity 12 as a press-in part. As a result, firstly sealing of the cavity and secondly, by means of the press fit, secure fixing of the compression-spring body 24 in the brush body 11 is achieved by press fitting, by means of which the supporting forces are absorbed. The plug 15 is unnecessary in this case. The disconnection apparatus 20 is particularly simple as a result, since this is reduced to a single component, which has to be inserted into the cavity 12.

The fact that the compression-spring body 24 and the disconnection body 21 are formed from plastic and, for example, are implemented in a particularly advantageous way as a one-piece component, means that the number of necessary components of the disconnection apparatus 20 can be reduced considerably. As a result, the disconnection apparatus 20 is substantially simplified, compact and inexpensive.

1. A carbon brush with disconnection apparatus, comprising:
a brush body defining a cavity; and,
a disconnection body including:
electrically insulating material, and
a preloaded compression-spring body configured to act resiliently on the disconnection body,
wherein at least one of the compression-spring body and the disconnection body is formed of plastic.

2. The carbon brush as claimed in claim 1, wherein the compression-spring body is formed from thermoplastic.

3. The carbon brush as claimed in claim 1, wherein the compression-spring body is formed from an elastomer.

4. The carbon brush as claimed in claim 1, wherein the compression-spring body is formed from at least one spring.

5. The carbon brush as claimed in claim 4, wherein:
the at least one spring is formed as a spring bellows or has spring turns, and
when the at least one spring is in a preloaded, compressed state, the spring turns are located at least partly inside one another, shortening the at least one spring.

6. The carbon brush as claimed in claim 1, wherein the compression-spring body is configured to close an end of the cavity and seal against ingress of material from a plug introduced above.

7. The carbon brush as claimed in claim 1, wherein the compression-spring body is formed from a plastic foam body.

8. The carbon brush as claimed in claim 1, wherein the compression-spring body is formed as one of a hollow body and a solid body.

9. The carbon brush as claimed in claim 1, wherein:
the compression-spring body and the disconnection body are combined to form an integral one-piece plastic component, and
a part representing the disconnection body also consisting of includes plastic.

10. The carbon brush as claimed in claim 1, wherein:
the compression-spring body has one end,
a cylindrical extension is formed in one piece with the one end, and
the compression-spring body with the cylindrical extension configured to be pressed into the cavity as a press-in part and held in the cavity tightly and firmly by a press fit.
